(19) United States
(12) Patent Application Publication
(10) Pub. No.: US 2011/0223865 A1
(43) Pub. Date: Sep. 15, 2011

(54) COMPUTER INPUT DEVICE WITH BLUETOOTH ARRANGEMENT FOR OPERATING COMPUTERS BY SWITCHING

(75) Inventor: YUNG-LUNG LIU, Ta Ya Shiang (TW)

(73) Assignee: Sunrex Technology Corp., Ta Ya Shiang (TW)

(21) Appl. No.: 12/724,301

(22) Filed: Mar. 15, 2010

(51) Int. Cl. H04B 7/005; G06F 3/033; G06F 3/02

(52) U.S. Cl. 455/41.3; 345/163; 345/168

(57) ABSTRACT

A Bluetooth apparatus is mounted to a computer input device (e.g., mouse) and includes a Bluetooth module for storing a plurality of unique IDs each corresponding to one of a plurality of Bluetooth-actuated computers, the Bluetooth module comprising a push button switch projecting out of the computer input device and a Bluetooth signal transmission unit electrically connected to a PCB of the computer input device; and a plurality of LED indicators mounted on a housing of the computer input device and electrically connected to the PCB. A pressing of the push button switch will switch the computer being operated to be idle and activate a next computer.

### BACKGROUND OF THE INVENTION

1. Field of Invention

The invention relates to Bluetooth technology and more particularly to a computer input device (e.g., mouse or keyboard) having a Bluetooth arrangement for operating at least two computers by switching by manipulating the Bluetooth arrangement.

2. Description of Related Art

Bluetooth is a short distance wireless communication technology of wirelessly transmitting information (e.g., text, voice, and/or video data) within a range of 10 to 100 m with up to 1 Mbps.

A Bluetooth-enabled device (i.e., Bluetooth device) enters a connect state for communication with other Bluetooth devices through the states of inquiry or the like. In this process, the Bluetooth devices are designated as a master and slaves according to their roles.

To establish a new connection between Bluetooth devices within the range of each other, the devices must coincide in operation clock and frequency pattern. In the inquiry state, a master repeatedly transmits signals at a frequency to let slaves synchronize to the frequency pattern.

U.S. Pat. No. 7,308,231 entitled “Computer mouse with Bluetooth hand-free handset” comprises an electric source module for supplying power to the computer input device, comprising a voltage step-up circuit and a battery, in which the battery can be a one-time-battery or a rechargeable battery used as the electric source for the computer input device; an optical mouse circuit for detecting movement vector caused by a movement of the computer input device; a Bluetooth module coupled to the optical mouse circuit. The module is further connected to an antenna, a power LED for indicating whether the computer input device is powered, and a link LED for indicating whether the computer input device is in a communication state; an echo cancellation circuit coupled to the Bluetooth module for canceling echoes of audio signals; a sound receptor coupled to the echo cancellation circuit for receiving audio signals; an audio signal amplifying circuit coupled to the echo cancellation circuit for receiving and amplifying the audio signals outputted from the echo cancellation circuit; and a loudspeaker coupled to the audio signal amplifying circuit.

Typically, a computer can be operated by manipulating a mouse or a keyboard, and two mice or keyboards are required to operate two computers respectively. However, the well known configuration is not convenient in use. Thus, a need for improvement exists.

### SUMMARY OF THE INVENTION

It is therefore one object of the invention to provide a Bluetooth apparatus mounted to a computer input device, comprising a Bluetooth module for storing a plurality of unique IDs each corresponding to one of a plurality of Bluetooth-actuated computers, the Bluetooth module comprising a push button switch projecting out of the computer input device and a Bluetooth signal transmission unit electrically connected to a PCB of the computer input device; and a plurality of LED indicators mounted on a housing of the computer input device and electrically connected to the PCB.

Preferably, the computer input device is a Bluetooth mouse.

It is another object of the invention to provide a Bluetooth apparatus mounted to a computer input device, comprising a Bluetooth module for storing a plurality of unique IDs each corresponding to one of a plurality of Bluetooth-actuated computers, the Bluetooth module comprising a push button switch projecting out of the computer input device and a Bluetooth signal transmission unit electrically connected to a PCB of the computer input device; and an electronic display device mounted on the computer input device and electrically connected to the PCB.

Preferably, the computer input device is a Bluetooth keyboard.

The above and other objects, features and advantages of the invention will become apparent from the following detailed description taken with the accompanying drawings.

### BRIEF DESCRIPTION OF THE DRAWINGS

FIG. 1 is a perspective view of a Bluetooth mouse according to a first preferred embodiment of the invention;

FIG. 2 is an exploded view of the Bluetooth mouse shown in FIG. 1;

FIG. 3 is a perspective view of two computers being operated by manipulating the Bluetooth mouse of FIG. 1 in cooperation with a typical keyboard;

FIG. 4 is a perspective view of a Bluetooth keyboard according to a second preferred embodiment of the invention; and

FIG. 5 is a perspective view of two computers being operated by manipulating the Bluetooth keyboard of FIG. 4 in cooperation with a typical mouse.

### DETAILED DESCRIPTION OF THE INVENTION

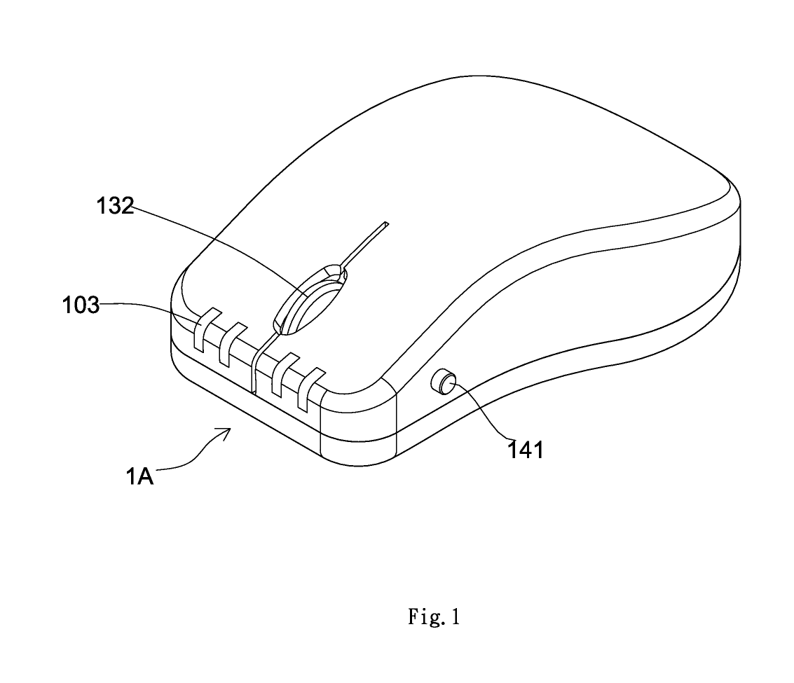

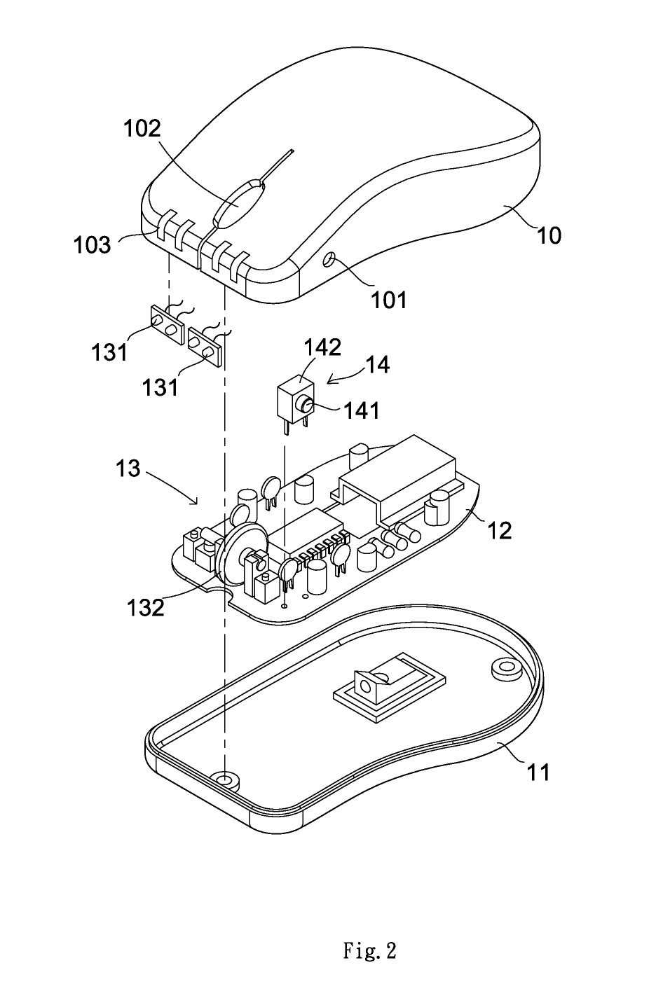

Referring to FIGS. 1 to 3, a computer input device (e.g., a wireless optical mouse) with a Bluetooth arrangement (hereinafter, referred to as a Bluetooth mouse) in accordance with a first preferred embodiment of the invention is generally designated by numeral 1A. The Bluetooth mouse 1A comprises the following components as discussed in detail below.

A housing 10 comprises a side opening 101, a top opening 102, and four front openings 103. A PCB (printed circuit board) 12 is mounted on a base 11.

An IC (integrated circuit) module 13 is electrically connected to and mounted on the PCB 12. The IC module 13 comprises four LED (light-emitting diode) indicators 131 mounted in the front openings 103 respectively, and a scroll wheel 132. A Bluetooth module 14 is electrically connected to and mounted on the PCB 12. The Bluetooth module 14 comprises a push button switch (e.g., a two-section push button switch) 141 and a Bluetooth signal transmission unit 142.

In an assembly state of the Bluetooth mouse 1A, the base 11 is releasably secured to the housing 10 in a manner well known in the art. Both the PCB 12 and the IC module 13 are mounted in the Bluetooth mouse 1A. The push button switch 141 projects out of the side opening 101. The scroll wheel 132 is rotatably mounted in the top opening 102.

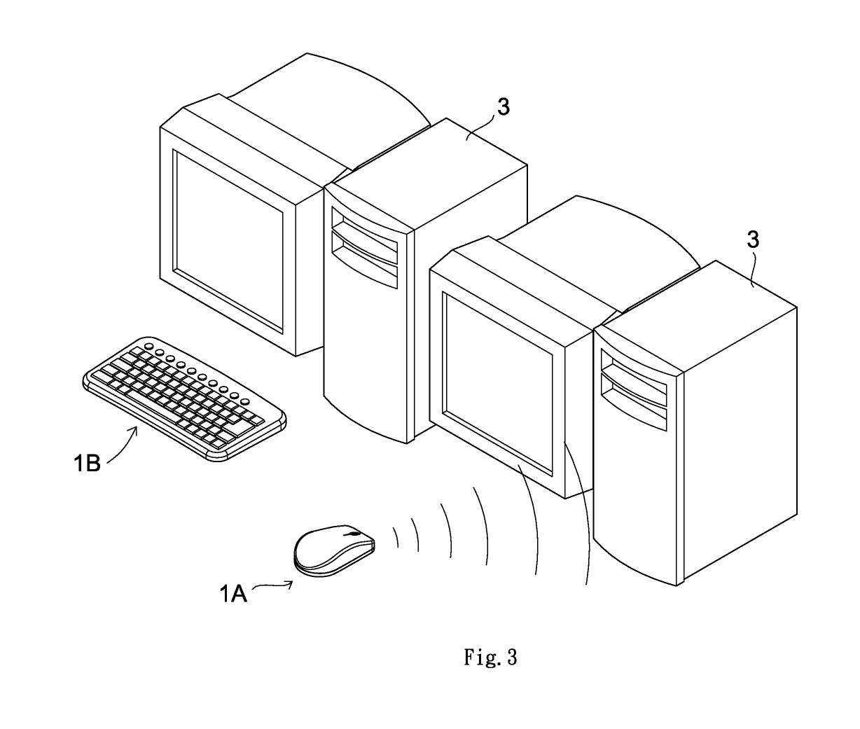

As shown in FIGS. 1 and 3 specifically, a user may manipulate the Bluetooth mouse 1A in cooperation with a conventional keyboard 1B to operate a plurality of computers (two are shown) 3. The computers 3 are Bluetooth-actuated devices and each computer 3 corresponds to one of a plurality of unique IDs (identifications) stored in the Bluetooth module 14 (i.e., stored in the Bluetooth signal transmission unit 142).

For example, prior to a switching operation, the leftmost LED indicator 131 is lit and other LED indicators 131 are dimmed. That is, the left computer 3 is being operated by the Bluetooth mouse 1A and the right computer 3 is idle. Alternatively, the LED indicators 131 are replaced with electronic display devices for showing decimal numerals in other embodiments.

A user may press the push button switch 141 to switch the operation from the left computer 3 to the right computer 3. In detail, after the pressing the Bluetooth signal transmission unit 142 repeatedly transmits signals at an operation frequency to let the computers 3 synchronize to the frequency pattern. After a successful communication, the ID of the left computer 3 is disabled and the ID of the immediately next computer (i.e., the right) computer 3 is enabled. Moreover, the LED indicator 131 next to the leftmost LED indicator 131 is lit and other LED indicators 131 are dimmed. The user can identify which computer 3 is being operated by the Bluetooth mouse 1A by observing brightness or dimness of the LED indicators 131. Further, a quick switch operation is carried out.

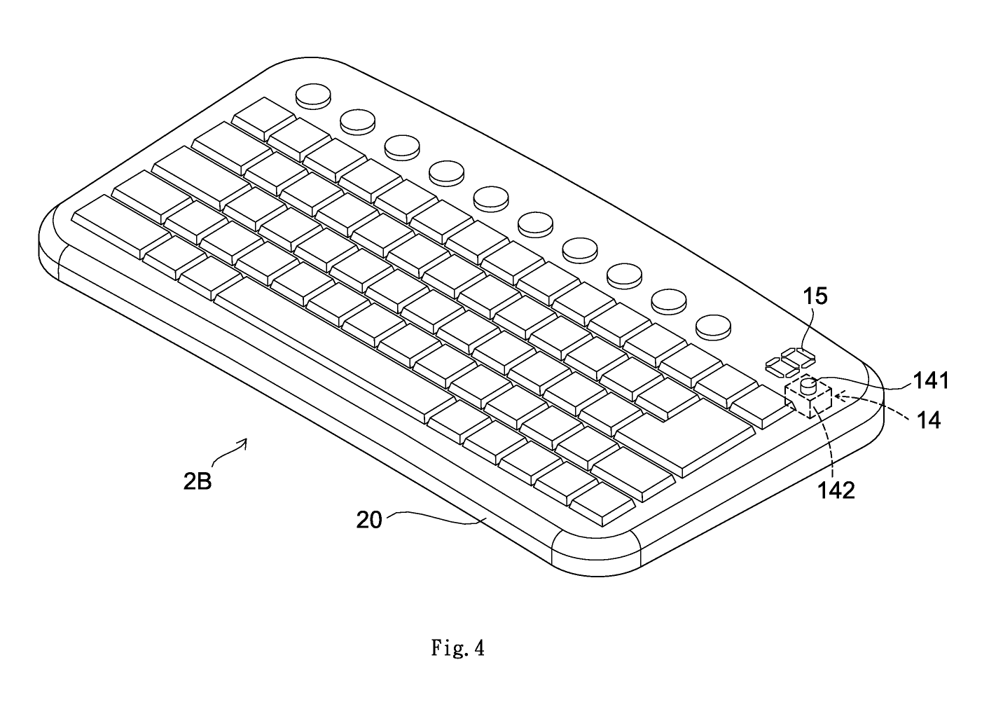

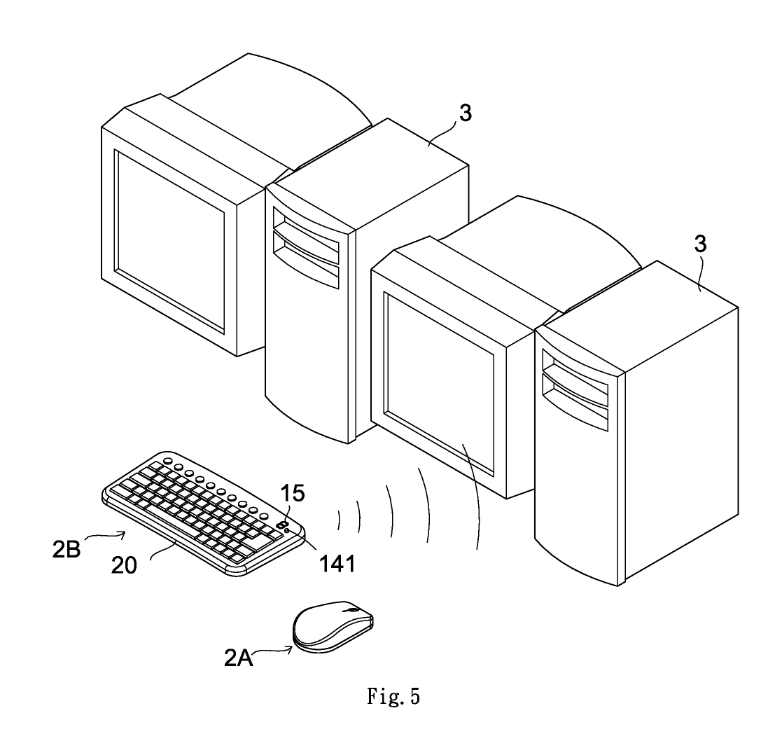

Referring to FIGS. 4 and 5, a computer input device (e.g., a wireless keyboard) with a Bluetooth arrangement (hereinafter, referred to as a Bluetooth keyboard) in accordance with a second preferred embodiment of the invention is generally designated by numeral 2B. The Bluetooth keyboard 2B comprises a keyboard housing 20, a Bluetooth module 14 including a push button switch (e.g., a two-section push button switch) 141 and a Bluetooth signal transmission unit 142, and an electronic display device 15 (e.g., a seven-segment display as shown).

In an assembly state of the Bluetooth keyboard 2B, the electronic display device 15 is mounted on, for example, a right top corner of a top surface of the keyboard housing 20 and the Bluetooth module 14 is mounted beside the electronic display device 15 with the push button switch 141 being exposed.

As shown in FIG. 5 specifically, a user may operate the Bluetooth keyboard 2B in cooperation with a conventional wireless optical mouse 2A to operate a plurality of computers (two are shown) 3. The computers 3 are Bluetooth-actuated devices and each computer 3 corresponds to one of a plurality of unique IDs stored in the Bluetooth module 14 (i.e., stored in the Bluetooth signal transmission unit 142).

For example, prior to a switching operation, a decimal numeral “1” is shown on the electronic display device 15. That is, the left computer 3 is being operated by the Bluetooth keyboard 2B and the right computer 3 is idle.

A user may press the push button switch 141 to switch the operation from the left computer 3 to the right computer 3. In detail, after the pressing the Bluetooth signal transmission unit 142 repeatedly transmits signals at an operation frequency to let the computers 3 synchronize to the frequency pattern. After a successful communication, the ID of the left computer 3 is disabled and the ID of the immediately next computer (i.e., the right) computer 3 is enabled. Moreover, a decimal numeral “2” (i.e., increase in value) is shown on the electronic display device 15. Alternatively, a default decimal numeral (e.g., “1”) is shown on the electronic display device 15 if the previously shown decimal numeral is “2” which is the maximum value in this embodiment. The user can identify which computer 3 is being operated by the Bluetooth keyboard 2B by observing the decimal numeral change shown on the electronic display device 15. Further a quick switch operation is carried out.

While a Bluetooth mouse and a Bluetooth keyboard are described as preferred embodiments of the invention, it is understood that Bluetooth earphones, Bluetooth loudspeakers, or other Bluetooth devices are equally applicable without departing from the scope of the invention.

While the push button switch is described as a two-section push button switch in the above preferred embodiments of the invention, it is understood that a push button switch having at least three sections are equally applicable without departing from the scope of the invention if there are at least three computers to be operated.

It is envisaged by the invention that a computer input device incorporating a Bluetooth module of the invention is adapted to operate more than one computer by switching. This is a significant contribution of the invention to the advancement of the art which, as discussed in the background section and for example, two mice or keyboards are required to operate two computers respectively.

While the invention herein disclosed has been described by means of specific embodiments, numerous modifications and variations could be made thereto by those skilled in the art without departing from the scope and spirit of the invention set forth in the claims.

What is claimed is:

1. A Bluetooth apparatus mounted to a computer input device, comprising:
a Bluetooth module for storing a plurality of unique IDs (identifications) each corresponding to one of a plurality of Bluetooth-actuated computers, the Bluetooth module comprising a push button switch projecting out of the computer input device and a Bluetooth signal transmission unit electrically connected to a PCB (printed circuit board) of the computer input device; and
a plurality of LED (light-emitting diode) indicators mounted on a housing of the computer input device and electrically connected to the PCB.

2. The Bluetooth apparatus of claim 1, wherein the push button switch is a multi-section push button switch.

3. The Bluetooth apparatus of claim 1, wherein the IDs are stored in the Bluetooth signal transmission unit.

4. The Bluetooth apparatus of claim 1, wherein one of the LED indicators is lit and the remaining LED indicators are dimmed when the computer input device is turned on and the computers are turned on with one of the computers being operated such that a pressing of the push button switch will cause the Bluetooth signal transmission unit to repeatedly transmit signals at an operation frequency to let the computers synchronize to a predetermined frequency pattern, and after a successful communication the currently lit LED indicator is dimmed, a next one of the LED indicators is lit, the computer being operated is deactivated, and a next one of the computers is activated.

5. The Bluetooth apparatus of claim 5, wherein after the successful communication, the ID of the computer being operated is disabled and the ID of the next one of the computers is enabled.

6. The Bluetooth apparatus of claim 1, wherein the computer input device is a Bluetooth mouse comprising a housing including a side opening with the push button switch projecting out of, a top opening with a scroll wheel of the Bluetooth mouse being rotatably mounted therein, and a plurality of front openings with the LED indicators being mounted therein; a base releasably secured to the housing and with the PCB mounted thereon; and an IC (integrated circuit) module electrically connected to and mounted on the PCB.

7. A Bluetooth apparatus mounted to a computer input device, comprising:
a Bluetooth module for storing a plurality of unique IDs (identifications) each corresponding to one of a plurality of Bluetooth-actuated computers, the Bluetooth module comprising a push button switch projecting out of the computer input device and a Bluetooth signal transmission unit electrically connected to a PCB (printed circuit board) of the computer input device; and
an electronic display device mounted on the computer input device and electrically connected to the PCB.

8. The Bluetooth apparatus of claim 7, wherein the push button switch is a multi-section push button switch.

9. The Bluetooth apparatus of claim 7, wherein the IDs are stored in the Bluetooth signal transmission unit.

10. The Bluetooth apparatus of claim 7, wherein a predetermined decimal numeral is shown on the electronic display device when the computer input device is turned on and the computers are turned on with one of the computers being operated such that a pressing of the push button switch will cause the Bluetooth signal transmission unit to repeatedly transmit signals at an operation frequency to let the computers synchronize to a predetermined frequency pattern, and after a successful communication the predetermined decimal numeral shown on the electronic display device is increased in value or the predetermined decimal numeral is shown if the previous decimal numeral is a maximum decimal numeral of the electronic display device, the computer being operated is deactivated, and a next one of the computers is activated.

11. The Bluetooth apparatus of claim 7, wherein after the successful communication, the ID of the computer being operated is disabled and the ID of the next one of the computers is enabled.

12. The Bluetooth apparatus of claim 7, wherein the computer input device is a Bluetooth keyboard with the electronic display device being mounted on a right top corner of a top surface of the Bluetooth keyboard, the Bluetooth module being mounted beside the electronic display device, and the push button switch being exposed.
